(19) United States
(12) Patent Application Publication
(10) Pub. No.: US 2006/0080466 A1
(43) Pub. Date: Apr. 13, 2006

(54) Web page upload method, terminal device, computer program, and recording medium

(75) Inventors: Naoya Yamaguchi, Tokyo (JP); Kenji Goshima, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/523,514

(22) PCT Filed: Jul. 31, 2003
(86) PCT No.: PCT/JP03/09765

§ 371 Date: Feb. 4, 2005

(30) Foreign Application Priority Data
Aug. 6, 2002 (JP) 2002-228200

(51) Int. Cl. G06F 15/16

(52) U.S. Cl. 709/250

(57) ABSTRACT

The present invention relates to a web page uploading method in which whether or not a web page is suitable for being made public can be checked without imposing a burden on an administrator and a web server. When a client computer in which a software for editing and uploading a web page is installed is instructed to upload the web page (S401), the client computer checks whether or not predetermined bad words are contained in the web page prior to uploading the web page to the web server (S402 to S406). Then, the web page subjected to the checking operation in this manner is uploaded (S409) and the data file representing the result of the checking operation is uploaded (S410), thereby completing the uploading of the web page.

### FIELD OF THE INVENTION

The present invention relates to a web page uploading method and particularly to a web page uploading method in which whether or not a web page is suitable for being made public can be checked without imposing a burden on an administrator and a web server, a terminal device for achieving the web page uploading method, a computer program for achieving the uploading method and a recording medium in which the computer program is stored.

### DESCRIPTION OF THE PRIOR ART

Conventionally, in order to check whether or not a web page to be uploaded to a web server and made public on the Internet or a LAN contains inappropriate phrases (hereinafter referred to as “bad words”), it is necessary for the administrator of the web page or others concerned to visually check the web page after it is made public or when it is about to be made public, or otherwise it is necessary for the web server to do a text search on the web page.

However, visually checking the web page is a very onerous job for the administrator of the web page or any other person concerned. Further, in the case where it takes a long time before bad words are found, a web page containing bad words may remain open to the public for a long time. Therefore, it is difficult to easily and quickly remove a web page containing an inappropriate phrase.

To the contrary, in the case where a web server does a text search for finding inappropriate phrases in a web page, web pages containing inappropriate phrases can be more easily and quickly found than in the case where the administrator of the web page or other person concerned visually checks the web page to find inappropriate phrases. However, having the web server automatically check the contents of web pages puts a heavy burden on the web server. This is because the web server collectively administers and makes public the web contents of numerous users, so that to have the web server also check the contents of the web page would place a great burden on web server operation and slow the web server in the operations it has to conduct.

On the other hand, whether or not a web page should be made public greatly depends upon the subjective values of the administrator of the web server. For example, although the word “fool,” which is commonly considered to be a bad word, is sometimes used to scorn or belittle another person, it is often used otherwise, and the decision as to whether or not the word “fool” is used as a bad word therefore depends upon the subjective values of the person making the judgment. As a consequence, it is extremely difficult to have the web server judge whether or not a web page should be made public.

### SUMMARY OF THE INVENTION

It is therefore an object of the present invention to provide a web page uploading method in which whether or not a web page is suitable for being made public can be checked without imposing a burden on an administrator and a web server, and the like.

The above object of the present invention can be accomplished by a web page uploading method adapted for uploading a web page from a client computer including at least software for uploading a web page to a web server, the client computer being constituted so as to check whether a web page contains predetermined phrases prior to uploading the web page and uploading data regarding a result of the check together with the web page.

According to the present invention, since the client computer checks whether or not a web page to be uploaded contains inappropriate phrases prior to uploading the web page, the web server can utilize the result of the check made by the client computer for judging whether or not the web page should be made public. In particular, since the client computer first checks whether or not a web page to be uploaded contains inappropriate phrase, it is possible to markedly reduce the burden of the web server required for judging whether or not the web page should be made public.

In a preferred aspect of the present invention, the client computer includes a word list in which the inappropriate phrases to be checked are registered and is constituted so as to refer to the word list, thereby checking whether or not the web page to be uploaded contains inappropriate phrases.

According to this preferred aspect of the present invention, since the client computer is constituted so as to check whether or not the web page to be uploaded contains inappropriate phrases using the word list in which predetermined phrases are registered, it is possible to always appropriately check whether or not the web page to be uploaded contains inappropriate phrases only by timely updating of the word list.

In a further preferred aspect of the present invention, the client computer is constituted so as to download the word list from the web server prior to checking whether or not the web page contains predetermined phrases.

According to this preferred aspect of the present invention, since the word list is stored in the web server in the form of a master file and the client computer is constituted so as to download the word list from the web server when it checks whether or not the web page to be uploaded contains inappropriate phrases, it is possible for the client computer to always make the check using the most recent word list.

The above object of the present invention can be also accomplished by a terminal device constituted so as to be connectable to a web server via a network, which comprises at least means for uploading a web page to a web server, means for checking whether or not the web page contains predetermined phrases prior to uploading the web page to the web server and means for uploading data regarding a result of the check to the web server together with the web page.

According to the present invention, since the terminal device is constituted so as to check whether or not the web page to be uploaded contains inappropriate phrases prior to uploading the web page, the web server can utilize the result of the check made by the client computer for judging whether or not the web page should be made public. In particular, since the terminal device first checks whether or not a web page to be uploaded contains inappropriate phrase, it is possible to markedly reduce the burden on the web server when judging whether or not the web page should be made public.

The above object of the present invention can be also accomplished by a computer program for enabling a client computer in a client server system in which a web server and the client computer are connected to other via a network to perform at least a step of checking whether or not a web page contains predetermined phrases prior to uploading the web page to the web server, and a step of uploading a result of the checking to the web server together with the web page.

According to the present invention, it is possible to constitute a client computer by installing the above defined computer program therein so that it can check whether or not the web page to be uploaded contains inappropriate phrases prior to uploading the web page to the web server.

The above object of the present invention can be also accomplished by a computer-readable recording medium in which is recorded a computer program for enabling a client computer in a client server system in which a web server and the client computer are connected to other via a network to perform at least a step of checking whether or not a web page contains predetermined phrases prior to uploading the web page to the web server, and a step of uploading a result of the check to the web server together with the web page.

According to the present invention, it is possible to constitute a client computer by setting the above defined recording medium therein and installing the above defined computer program therein so that it can check whether or not a web page to be uploaded contains inappropriate phrases prior to uploading the web page to the web server.

### BRIEF DESCRIPTION OF THE DRAWINGS

FIG. 1 is a schematic view showing a client server system to which a checking method of a web page that is a preferred aspect of the present invention has been applied.

FIG. 2 is a block diagram showing a hardware configuration of each of a web server 101 and a client computer 102.

FIG. 3 is a view showing a software configuration of a client computer 102 and a client computer 106.

FIG. 4 is a flow chart showing steps for uploading a web page conducted by a client computer 102.

FIG. 5 is a flow chart showing steps for uploading a web page conducted by a client computer 102 in another preferred embodiment of the present invention.

### DESCRIPTION OF THE PREFERRED EMBODIMENTS

Hereinafter, preferred embodiments of the present invention will be described in detail with reference to accompanying drawings.

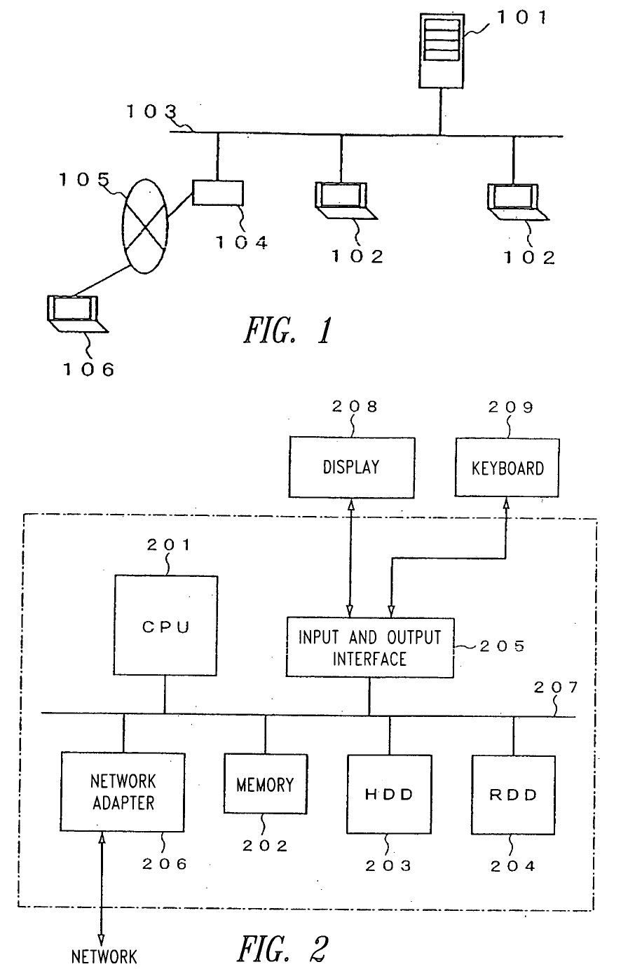

FIG. 1 is a schematic view showing a client server system to which a checking method of a web page that is a preferred aspect of the present invention has been applied.

As shown in FIG. 1, the system has a configuration in which a web server 101 and a client computer 102 are connected to a LAN 103. Further, the LAN 103 is also connected to the Internet 105 via Internet connection devices 104 such as a broad band router, a modem or the like and a client computer 106 is connected to the web server 101 via the internet 105 and the LAN 103 similarly to the client computer 102.

The web server 101 is constituted as a personal computer or a work station having a data base containing web contents. Web server software is installed in the web server 101 and the web server 101 uses the web server software to transmit web contents stored therein in response to requests from the client computer 102 and launches a CGI script.

On the other hand, the client computer 102 and the client computer 106 are each constituted as a personal computer having web browsing capability, web editing capability, FTP capability and the like. These capabilities can be achieved by a web browser, a web page editing program, FTP software and the like. It goes without saying that a device driver and an operation system are installed in each of the client computer 102 and the client computer 106 and other application software may be installed therein. The same applies to the above mentioned web server 101.

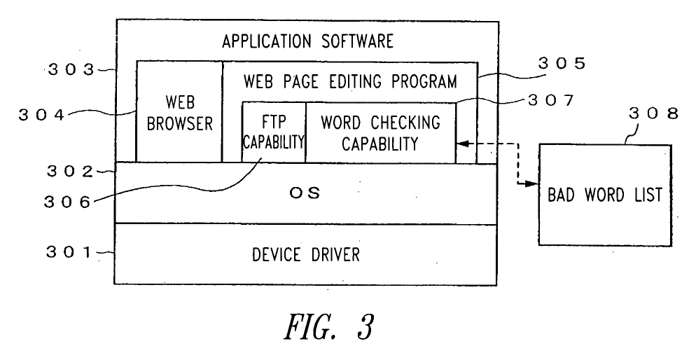

FIG. 2 is a block diagram showing the hardware configuration of the web server 101 and the client computer 102.

As shown in FIG. 2, the web server 101 and the client computer 102 each includes a CPU 201, a memory 202, a hard drive disk (HDD) 203, a removable disk drive 204 which can reproduce data from and record data in recording media such as a flexible disk, a CD-ROM, a CD-R, a DVD-ROM or the like, an input and output interface 205 and a LAN adapter 206, which are connected via a bus 207. The web server 101 and the client computer 102 are each connected via the input and output interface 205 to a display 208, a keyboard 209 and the like and are each connected via the LAN adapter 206 to the LAN 103.

Each of the functions of the web server 101 and the client computer 102 can be achieved by reading various programs installed therein from the hard disk drive 203 thereof when the computer is started or when the programs are executed, loading it in the memory 202, and having the CPU 201 sequentially execute programs in accordance with the software loaded in the memory 202.

The configuration of the client computer 106 is basically the same as that of the client computer 102 but, depending on how it is connected to the internet 105, a communicating means such as an ADSL modem may be used instead of the LAN adapter 206.

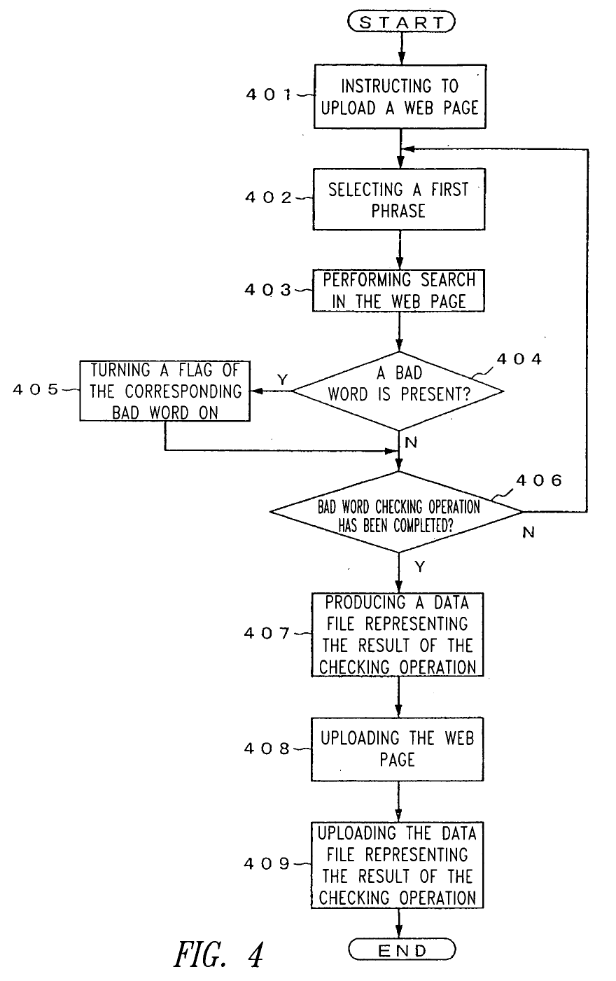

FIG. 3 is a view showing the software configuration of each of the client computer 102 and the client computer 106.

As shown in FIG. 3, the client computer 102 and the client computer 106 each includes a device driver 301, an operating system (OS) 302 and application software 303. The application software 303 includes a web browser 304 for browsing web pages made public by the web server 101 and a web page editing program 305 for producing and correcting web pages. The web page editing program 305 has file transferring capability (FTP capability) 306 for uploading web pages to the web server. FTP software for achieving the FTP capability 306 is incorporated in the web page editing program 305 as a part thereof and supplied to each of the client computer 102 and the client computer 106.

The web page editing program 305 also has word checking capability 307 for checking whether or not predetermined phrases are contained in a web page. The word checking capability 307 is a text search function for conducting a search of predetermined characters in an HTML text file in a web page, for example. When an edited web page is to be uploaded, whether or not the web page contains bad words is checked using the word checking capability 307. The result of the check is uploaded to the web server 101 together with the web page.

The client computer 102 further includes a bad word list 308 that the web page editing program 305 uses to check whether or not a web page contains bad words. The bad word list 308 is constituted as a text file in which a number of bad words are recorded in a predetermined format.

These programs may be supplied in the form of a recording medium such as a CD-ROM storing them, for example. In such a case, the software is installed in the client computer 102 by setting the recording medium in the removable disk drive 204, conducting a set-up operation and storing the software on the hard disk drive 203. Instead, the software may be downloaded via the internet 105. In such a case, the software is installed in the client computer 102 by storing the software downloaded via the LAN adapter 206 on the hard disk drive 203.

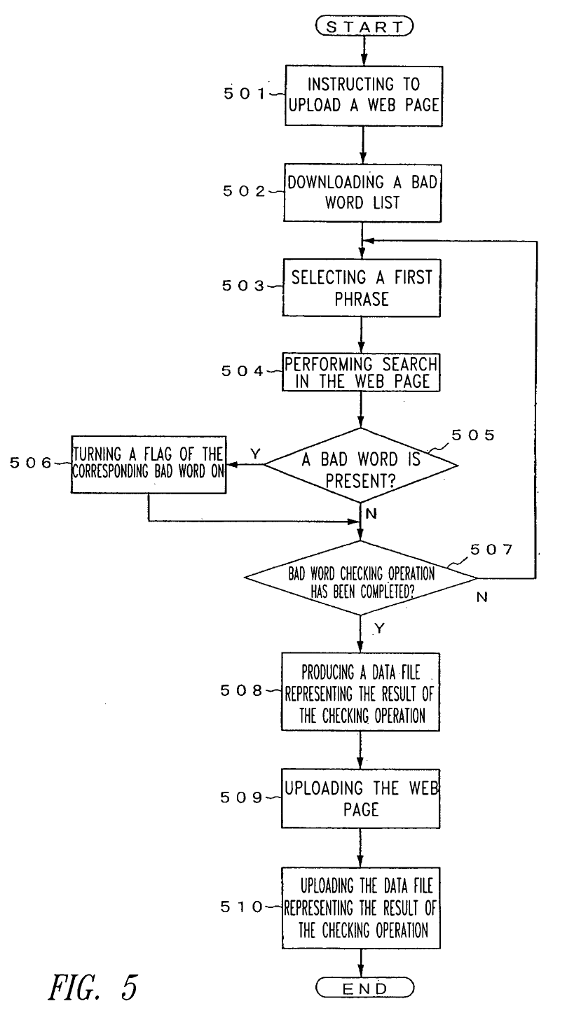

FIG. 4 is a flow chart showing steps for uploading a web page conducted by the client computer 102.

As shown in FIG. 4, when a web page has been edited by the client computer 102 and the client computer 102 is instructed to upload the web page (S401), the client computer 102 checks whether or not predetermined bad words are contained in the web page (S402 to S406).

Specifically, the client computer 102 first selects the first phrase registered in the bad word list (S402) and performs a keyword search on the whole HTML text file in the web page, preferably all data other than commands, using the selected phrase as a keyword (S403).

When a bad word that is a subject of the search is found as a result (S404Y), the client computer 102 turns the flag of the word on (S405). To the contrary, when no bad word is found (S404N), all flags are maintained off. This keyword search is repeated until all phrases registered in the bad word list have been checked (S402 to S405 and S406N).

When all words registered in the bad word list have been checked and the checking operation of the web page has been completed (S406Y), the result of the checking operation is recorded and a data file representing the result of the checking operation is produced (S407). The data file is constituted as text data of the corresponding bad words, for example.

Thereafter, the edited web page is uploaded (S408) and at the same time, the data file representing the result of the checking operation is uploaded (S409), thereby completing the uploading of the web page and the data file.

The web server 101 stores the thus uploaded web page and data file representing the result of the checking operation in a dedicated memory area assigned thereto in advance. When the uploaded web page is to be made public on the network, the web server 101 refers to the data file representing the result of the checking operation. When the web server judges that a bad word is contained in the uploaded web page, it displays a mark indicating that the bad word is contained in the home page on the display.

Therefore, the administrator of the web page can easily judge based on the mark displayed on the display whether or not the web page is suitable for being made public. Further, the administrator of the web page can easily judge whether or not the web page is suitable for being made public without checking the contents of the web page in detail.

In this preferred embodiment, although the explanation was made as to the case where the client computer 102 itself has the bad word list in advance, it is possible to constitute it in such a manner that the web server 101 has a bad word list in the form of a master file and when the client computer 102 checks whether or not bad words are contained in a web page, the bad word list is downloaded from the web server 101 to the client computer 102 so that the client computer 102 can refer to the bad word list and check whether or not bad words are contained in the web page.

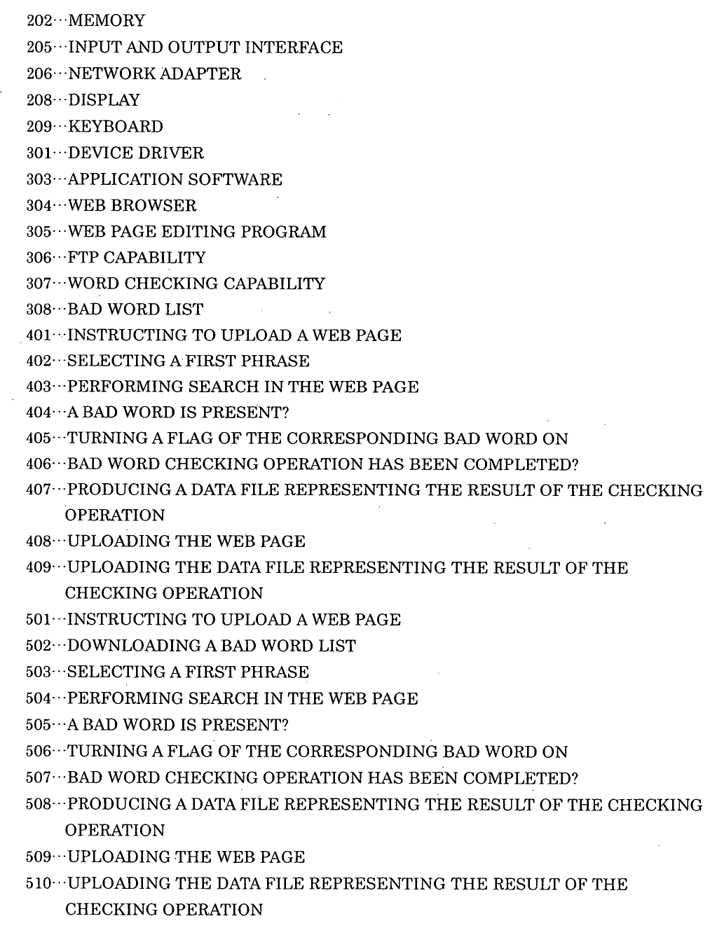

FIG. 5 is a flow chart showing steps for uploading a web page conducted by the client computer 102 in another preferred embodiment of the present invention.

As shown in FIG. 5, when a web page has been edited by the client computer 102 and the client computer 102 is instructed to upload the web page (S501), the client computer 102 downloads the most recent bad word list from the web server 101 prior to checking whether or not the web page contains bad words (S502). Thereafter, the client computer 102 checks whether or not predetermined bad words are contained in the web page (S503 to S507).

Specifically, the client computer 102 first selects the first phrase registered in the bad word list (S503) and performs a keyword search on the whole HTML text file in the web page, preferably all data other than commands, using the selected phrase as a keyword (S504).

As a result, when a bad word that is a subject of the search is found (S505Y), the client computer 102 turns the flag of the word on (S506). To the contrary, when no bad word is found (S505N), all flags are maintained off. This keyword search is repeated until all phrases registered in the bad word list have been checked (S503 to S506 and S507N).

When all words registered in the bad word list have been checked and the checking operation of the web page has been completed (S507Y), the result of the checking operation is recorded and a data file representing the result of the checking operation is produced (S508). The data file is constituted as text data of the corresponding bad words, for example.

Thereafter, the edited web page is uploaded (S509) and at the same time, the data file representing the result of the checking operation is uploaded (S5149), thereby completing the uploading of the web page and the data file.

Here, it is not absolutely necessary for a master file of the bad word list to be stored in the web server 101 and any one of independent data base servers may store it so that the bad word list can be supplied thereform onto the internet. In such a case, the client computer 101 accesses the independent data base server to obtain a bad word list and a web page is then started to be uploaded to the web server 101.

The present invention has thus been shown and described with reference to specific embodiments. However, it should be noted that the present invention is in no way limited to the details of the described arrangements but changes and modifications may be made without departing from the scope of the appended claims.

For example, in the above described preferred embodiments, although the explanation was made as to the case where the word checking operation for checking whether or not predetermined phrases are contained in a web page is conducted by doing a text search as to whether or not predetermined characters are present in an HTML text file in the web page, it is not absolutely necessary to conduct the word checking operation by doing such a text search and it is possible to effect character recognition processing on image data to be pasted in a web page, thereby extracting text data and to do a text search on the text data. In the case of conducting the word checking operation in this manner, the bad word checking can be effected on all characters to be posted on a web page.

Further, in the above described preferred embodiments, although the explanation was made as to the case where the web page editing program 305 has the FTP capability 306 and the word checking capability 307, it is not absolutely necessary for the web page editing program 305 to have the FTP capability 306 and the word checking capability 307 and it is possible to constitute the system so that a single FTP program independent from the web page editing program 305 has word checking capability and the word checking operation is conducted by the FTP software when a web page is to be transferred. In other words, the FTP software may be independent from other software or may be incorporated into other software as a part thereof insofar as a word checking operation can be conducted by the FTP software when a web page is to be uploaded.

As described above, according to the present invention, it is possible to provide a web page uploading method in which whether or not a web page is suitable for being made public can be checked without imposing a burden on an administrator and a web server, a terminal device for achieving the web page uploading method, a computer program for achieving the uploading method and a recording medium in which the computer program is stored.

1. A web page uploading method adapted for uploading a web page from a client computer including at least software for uploading a web page to a web server, the client computer being constituted so as to check whether a web page contains predetermined phrases prior to uploading the web page and uploading data regarding a result of the check together with the web page.

2. A web page uploading method in accordance with claim 1, wherein the client computer includes a word list in which the inappropriate phrases to be checked are registered and is constituted so as to refer to the word list, thereby checking whether or not the web page to be uploaded contains inappropriate phrases.

3. A web page uploading method in accordance with claim 2, wherein the client computer is constituted so as to download the word list from the web server prior to checking whether or not the web page contains predetermined phrases.

4. A terminal device constituted so as to be connectable to a web server via a network, which comprises at least means for uploading a web page to a web server, means for checking whether or not the web page contains predetermined phrases prior to uploading the web page to the web server and means for uploading data regarding a result of the check to the web server together with the web page.

5. A computer program for enabling a client computer in a client server system in which a web server and the client computer are connected to other via a network to perform at least a step of checking whether or not a web page contains predetermined phrases prior to uploading the web page to the web server, and a step of uploading a result of the checking to the web server together with the web page.

6. A computer-readable recording medium in which is recorded a computer program for enabling a client computer in a client server system in which a web server and the client computer are connected to other via a network to perform at least a step of checking whether or not a web page contains predetermined phrases prior to uploading the web page to the web server, and a step of uploading a result of the check to the web server together with the web page.
